(19) United States
(12) Patent Application Publication
(10) Pub. No.: US 2024/0411363 A1
(43) Pub. Date: Dec. 12, 2024

(54) HEADSET FOR DISPLAY OF VIDEOS

(71) Applicant: USADATA, Inc., New York, NY (US)

(72) Inventors: Michael Roger MESSANO, Upper Saddle River, NJ (US); Jonathan Casey RAPKIN, North Caldwell, NJ (US); Eric Joseph MURPHY, Seaford, NY (US)

(73) Assignee: USADATA, Inc., New York, NY (US)

(21) Appl. No.: 18/734,062

(22) Filed: Jun. 5, 2024

Related U.S. Application Data
(60) Provisional application No. 63/506,957, filed on Jun. 8, 2023.

(51) Int. Cl. G06F 3/01; G02B 27/00; G02B 27/01; G06F 16/735; H04N 21/466

(52) U.S. Cl. CPC G06F 3/013; G02B 27/0093; G02B 27/017; G06F 16/735; H04N 21/4668

(57) ABSTRACT

Systems and methods are disclosed for providing media presentations to a user. The methods include determining one or more media presentations to present to a user; providing one or more media presentations as options for selection by the user; receiving a selection of the user of one media presentation from the provided one or more media presentations; and transmitting the selected one media presentation to a display of a headset.

### CROSS-REFERENCE TO RELATED APPLICATIONS

This application claims priority to U.S. Provisional Patent Application No. 63/506,957 filed on Jun. 8, 2023, the entire contents of which are incorporated herein by reference.

### BACKGROUND OF THE DISCLOSURE

Modern media distribution systems enable a user to access more media content than ever before. However, given the large variety of media assets available to a user, it may be a challenging task for users of media services to efficiently locate content he or she is interested in for that particular time.

Selection of media, such as videos and audio/video combinations, has typically been performed by a physical input received by a user, such as a touch input on a smart phone and a mouse click of a particular video. The selected video can be of any desired topic based on the user's mood, etc. and can be selected with the aim of creating a desired outcome, such as a calm feeling.

This disclosure relates to providing media assets to a user, and more particularly, to systems and methods for presenting media content recommendations to the users.

### SUMMARY OF THE DISCLOSURE

In accordance with one or more embodiments, devices and methods are provided for providing one or more media presentations to a user and receiving that user's selection of the one media presentation to view.

### BRIEF DESCRIPTION OF THE DRAWINGS

The accompanying drawings, which are incorporated in and constitute a part of this specification, illustrate embodiments of the disclosure, and, together with the summary given above, and the detailed description of the embodiments below, serve as a further explanation and disclosure to explain and/or illustrate embodiments of the disclosure.

FIG. 1 is a front perspective view of a headset of an embodiment of the present disclosure;

FIG. 2 is a rear perspective view of a headset of an embodiment of the present disclosure;

FIG. 3A is an illustration of various images that can be displayed on one or more displays of a headset of an embodiment of the present disclosure;

FIGS. 3B-3C are illustrations of another embodiment of what can be displayed on one or more displays of a headset of an embodiment of the present disclosure;

FIG. 4 is a block diagram of a network environment for media presentations according to an embodiment of the present disclosure;

FIG. 5 is a flowchart of a method for providing media presentations to a user of an embodiment of the present disclosure;

FIG. 6 is a flow diagram illustrating training and operation of a machine learning model, according to an embodiment of the disclosure; and

FIG. 7 is a high-level block diagram of a computer system for implementing the systems and methods described herein.

### DETAILED DESCRIPTION OF THE DISCLOSURE

It is noted that the drawings of the present application are provided for illustrative purposes only and, as such, the drawings are not drawn to scale. It is also noted that like and corresponding elements are referred to by like reference numerals.

In the following description, numerous specific details are set forth, such as particular structures, components, materials, dimensions, processing steps and techniques, in order to provide an understanding of the various embodiments of the present application. However, it will be appreciated by one of ordinary skill in the art that various embodiments of the present application may be practiced without these specific details. In other instances, well-known structures or processing steps have not been described in detail in order to avoid obscuring the present application.

As used herein, the term “substantially” or “substantial”, is equally applicable when used in a negative connotation to refer to the complete or near complete lack of an action, characteristic, property, state, structure, item, or result. For example, a surface that is “substantially” flat would either be completely at, or so nearly flat that the effect would be the same as if it were completely flat.

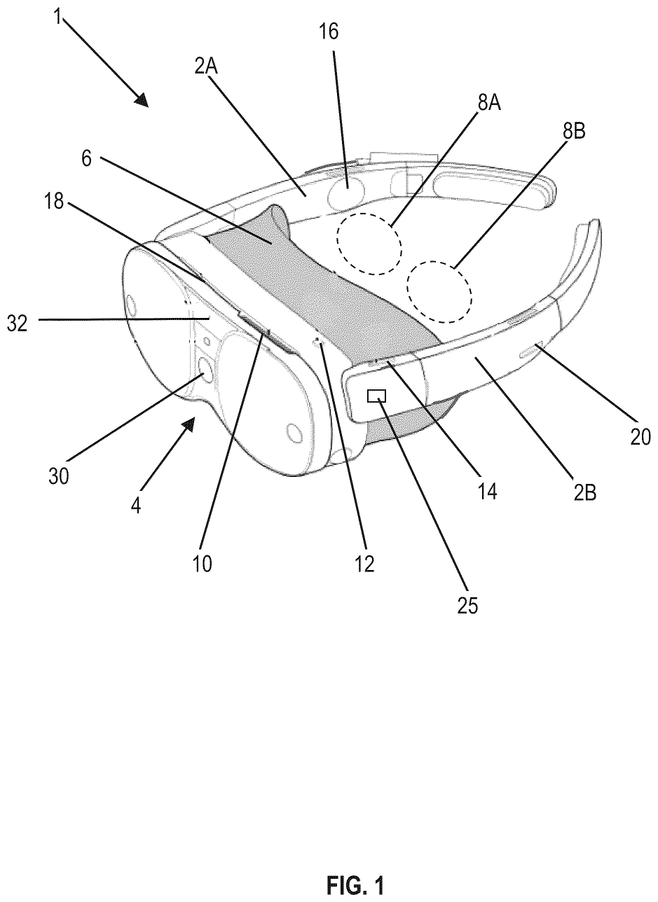

An embodiment of a headset 1 is shown, in a front perspective view, in FIG. 1. In this embodiment the headset 1 includes two arms, arm 2A and arm 2B, which are configured to extend around a portion of a user's head when the headset 1 is being worn. In other embodiments, a single arm can be included in headset 1, or any other suitable structure capable of maintaining a bridge 4 in a position, relative to a user's eye, eye 8A and/or eye 8B are shown for explanatory purposes.

Arm 2A and arm 2B are connected to each other with the bridge 4, which extends laterally across a user's face when the headset is in use. The arm 2A, arm 2B, bridge 4, and any other portion of headset 1 can be formed of any suitable material, such as metal(s), ceramic(s), carbon based material(s), foam(s), rubber(s), plastic(s), etc., and combinations thereof.

Also included on the bridge 4 is a shield 6, which is substantially flexible and can conform to a user's face, while substantially blocking light from entering towards the user's eye 8A and/or eye 8B. An optional vent 10 can be present between a portion of the shield 6 and a portion of the bridge 4 to allow for air transfer, moisture transfer, etc.

The headset 1 can include various inputs, which can be physical buttons and/or touch sensitive portions that can receive a touch input. One of these inputs is a power button 12 that can cause the headset components to operate or no, and a volume control 14. The volume control 14 can increase or decrease the media volume being emitted from the one or more optional speakers 16. The one or more optional speakers 16 can be included in and/or on the headset 1, alternatively or in addition to, the one ore more optional speakers can be separate, external to the headset 1 speakers, such as headphones, which can connect to the headset 1 for reception of the media through any suitable wired and/or wireless protocol, such as Bluetooth®.

The headset 1 can include one or more other inputs that can detect sound and/or any one or more physiologic values, with the gathered signals of these inputs being transmitted to a media system 140, discussed below. One input of headset 1 is a microphone 18, which can detect sounds created by the user and/or ambient sounds. Another input of headset 1 can be one or more physiologic sensors 20. This physiologic sensor(s) 20 can be included in and/or on the headset 1, alternatively or in addition to, the physiologic sensor(s) can be separate, external to the headset 1, such as one or more of a heart rate monitor, a blood pressure monitor, a pulse monitor, a respiration rate sensor, a blood oxygen sensor, a temperature sensor, a glucose sensor, and/or other physiologic sensor(s), which can connect to the headset 1 for reception of the measured physiologic data through any suitable wired and/or wireless protocol, such as Bluetooth®.

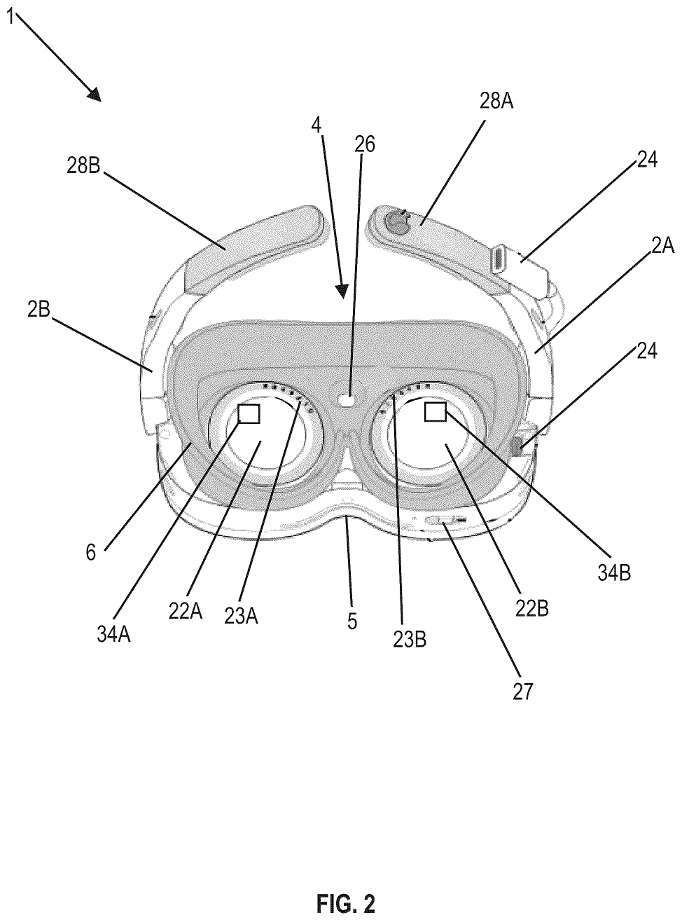

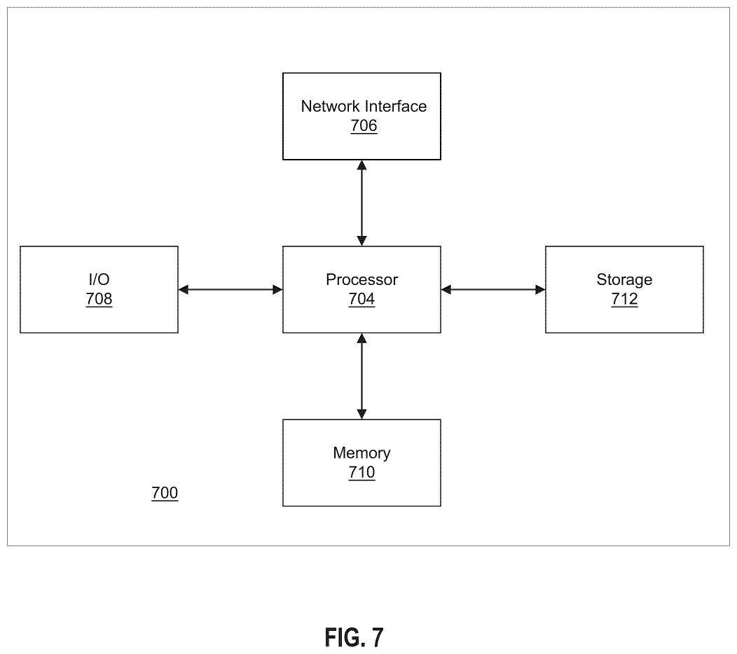

The headset 1 can also include a camera 30. The camera 30 can include a lens coupled with a sensor, such as a charge-coupled device (CCD), to capture image(s) from the front of the headset 1, substantially along the typical eyeline of the user. The camera 30, in conjunction with a suitable processor 25 (which can be included in/on or in a remote location from the headset 1, and can be the processor 704 of FIG. 7, discussed below) can, upon selection by the user or a another party, switch what is presented on one or both displays 22A and 22B (shown in FIG. 2) between the view from the camera 30 and a media presentation being shown on one or both displays 22A and 22B. Thus, the user can view their actual surroundings on one or both displays 22A and 22B, if they desire. As referred to herein, the media presentation can be a video only presentation, or media presentation can be a video and audio combination. The displays 22A and 22B can be the same type of display or different, each being any suitable electronic display that is capable of displaying video content to a user, such as a

The processor 25 can be one or more processors in, on and/or in a remote location from the headset 1, can be used to receive signals and transmit signals, as needed throughout the headset 1. For example, the processor 25 can control the delivery of electricity to a status light 32. The status light 32 can be any suitable light source, including a light emitting diode (LED). The status light 32 can illuminate according to output from the processor 25, and can be made to illuminate in different colors/blinking patterns, so that other parties not wearing the headset 1 can be aware. For example, if a user is viewing one type of media, the status light 32 can illuminate a green color, if the user is viewing their surroundings with camera 30, the status light 32 can illuminate a yellow color.

The headset 1 can include its own electrical power source, such as a battery, and/or can receive electrical power from any wireless or wired source.

FIG. 2 is a rear perspective view of headset 1, in the orientation a user would wear it. For example, one or both of the user's eyes would align with display 22A and/or display 22B, so that at least a portion of at least one of the user's eyes is covered by the headset 2 and/or shield 6. A user's nose (not shown) would rest on nose portion 5. Arms 2A and 2B would extend around a portion of the user's head (not shown).

In this embodiment each of arms 2A and 2B include a removable portion 28A and 28B, respectively. The removable portions 28A and 28B can be switched per user's requirements and/or preferences. Arms 2A and 2B may also rotate about a hinge in the vicinity of the bridge 4.

Around one or both displays 22A and 22B are diopter dials 23A and 23B. One or both of the diopter dials 23A and 23B can be adjusted to account for vision differences between a user's left eye as compared to their right eye, and vice versa so that the user can see the respective display 22A and 22B more clearly. The diopter dials 23A and 23B operate to modify the focal length of the displays 22A and/or 22B, so that each user can adjust one or both of the diopter dials 23A and 23B based on their specific vision characteristics.

The headset 1 can include a moving mechanism 27. This moving mechanism 27 can be manually adjusted and/or cause a powered movement of one or both of the displays 22A and 22B. Therefore, a user can interact with moving mechanism 27 to cause the displays 22A and 22B to move closer together, or further apart, to adjust for the specific wearer's pupillary distance.

The headset 1 can include a proximity sensor 26 on any internal portion of the headset 1. The proximity sensor 26, in conjunction with the processor 25, can be used to detect if the headset 1 is being worn by a user, by measuring the proximity between a near surface and the headset 1 itself. For example, whenever a surface is detected that is less than 1 inch from the proximity sensor 26, the processor 25 can determine that the headset 1 is being worn, and the processor 25 can cause that determination to be transmitted to another device, such as a third party's mobile device, desktop computer and/or server.

The headset 1 also includes one or more gaze sensors 34A and 34B, which are each configured to detect a gaze direction of at least one eye of the user. The one or more gaze sensors 34A and 34B can be used to detect the user's gaze direction for one or both of the user's eyes by any suitable way. For example, the one or more gaze sensors 34A and 34B can be used to identify a location of the user's gaze within a portion of the one or more displays 22A and 22B. This gaze tracking can be performed between the one or more gaze sensors 34A and 34B, together with the processor 25, to determine a direction in which one or both of the user's eyes are oriented at any given time, and to determine how long one or both of the user's eyes are oriented in that direction. Having identified the orientation of one or both eyes, as discussed below, a gaze direction can be determined and a focal region may be determined as the intersection of the gaze direction of each eye.

To detect the gaze direction of one or both of the user's eyes, the one or more gaze sensors 34A and 34B can perform an image capture process using any suitable sensor based camera. For example, the one or more gaze sensors 34A and 34B can be a standard camera, which can capture a sequence of images of the user's eye that may be processed to determine tracking information. As another example, the one or more gaze sensors 34A and 34B can be an event camera, which can be used to generate output in accordance with observed changes in brightness.

According to the first example, standard cameras refer to cameras which capture images of the environment, with the one or more gaze sensors 34A and 34B, at predetermined intervals, which can be combined to generate video content. For example, a camera of this type may capture thirty images (frames) each second, and these images may be output to processor 25 for feature detection (such as detection of the iris and/or pupil) or the like to be performed so as to enable tracking of the eye. Such a camera comprises a light-sensitive array that is operable to record light information during an exposure time, with the exposure time being controlled by a shutter speed (the speed of which dictates the frequency of image capture). The shutter may be configured as a rolling shutter (line-by-line reading of the captured information) or a global shutter (reading the captured information of the whole frame simultaneously), for example. Thus, the gaze direction of at least one eye of the user may be detected with this type of sensor.

In the second example, the one or more gaze sensors 34A and 34B can be an event camera, which may also be referred to as a dynamic vision sensor. Such cameras do not require a shutter as described above, and instead each element of the light-sensitive array (often referred to as a pixel) is configured to output a signal at any time a threshold brightness change is observed. This means that images are not output in the traditional sense-however an image reconstruction algorithm may be applied that is able to generate an image from the signals output by an event camera. The output of the event camera can be used for tracking without any image generation. One example of how this is performed is that of using an IR-sensitive event camera; when imaged using IR light, the pupil of the human eye displays a much higher level of brightness than the surrounding features. By selecting an appropriate threshold brightness, the motion of the pupil would be expected to trigger events (and corresponding outputs) at the one or more gaze sensors 34A and 34B. Thus, the gaze direction of at least one eye of the user may be detected with this type of sensor.

Each of the one or more gaze sensors 34A and 34B are provided as part of the headset 1. The location of the one or more gaze sensors 34A and 34B are shown for illustrative purposes only in FIG. 2, the one or more gaze sensors 34A and 34B can be located anywhere within the interior of the headset 1 such that a field of view associated with the one or more gaze sensors 34A and 34B includes at least the cornea, pupil and iris of the respective eye to allow detection of one or more of these structures. For example, a position of the pupil and reflections associated with the cornea may be detected by the one or more gaze sensors 34A and 34B, and an output indicative of these properties for the eye can be provided to the processor 25 to generate image(s) for display by the one or more displays 22A and 22B in dependence upon the gaze direction for the eye. For example, the processor 25 can generate a cursor image (gaze icon) based on the gaze direction for the eye, so that a user can gaze at different portions of the one or more displays 22A and 22B, causing the cursor image (gaze icon) to move within the images displayed one the one or more displays 22A and 22B.

Other detectable properties associated with the eye, other than tracking of eye structures, may be used by the one or more gaze sensors 34A and 34B for detecting the gaze direction. The one or more gaze sensors 34A and 34B are thus configured to detect the gaze direction of the eye and to generate an output indicative of the detected gaze direction of the eye. The one or more gaze sensors 34A and 34B can be configured to detect the gaze direction of the eye of the user and generate the output indicative of the detected gaze direction such that the gaze direction of the eye can be tracked.

Independent of the type of camera that is selected, the headset 1 of the present disclosure may optionally be configured to provide illumination to the eye in order to obtain an image. One example of this is the provision of an IR light source that is configured to emit light in the direction of one or both of the user's eyes; an IR camera may then be provided that is able to detect reflections from the user's eye in order to generate an image. IR is not visible to the human eye, and as such does not interfere with normal viewing of content on the displays 22A and 22B by the user.

In some embodiments, the one or more gaze sensors 34A and 34B, and/or the IR camera, or an additional sensor can be used to collect one or more image of a user's eye while the headset 1 is being worn. The image(s) can be collected of any suitable portion of one or both of the user's eye, including portions or entireties of the iris, the cornea, the pupil, the lens, etc. (including the vasculature of any of these portions) and can also be collected to estimate blinking duration and/frequency. Features of those image(s) can then be measured through use of processor 25 or any suitable remote processor, and analyzed to estimate the user's age.

To estimate the age, the features can be classified into age categories in any suitable way, for example by use of an age estimation deep learning model, which can be a classification model that receives the one or more features as input and performs a classification task to determine an estimated age class of the user of the headset 1 as a discrete value (e.g., age group 40-49). Alternatively, the age estimation deep learning model may be a regression model that receives the one or more features as input and performs a regression task to determine an estimated age value of the user of the headset 1 as a continuous value (e.g., 47.5 years old).

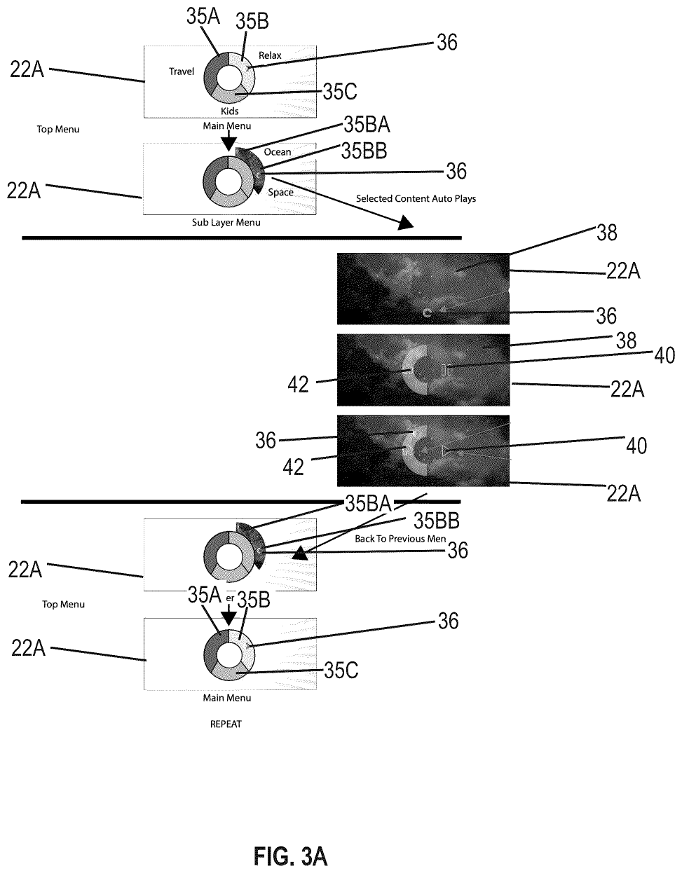

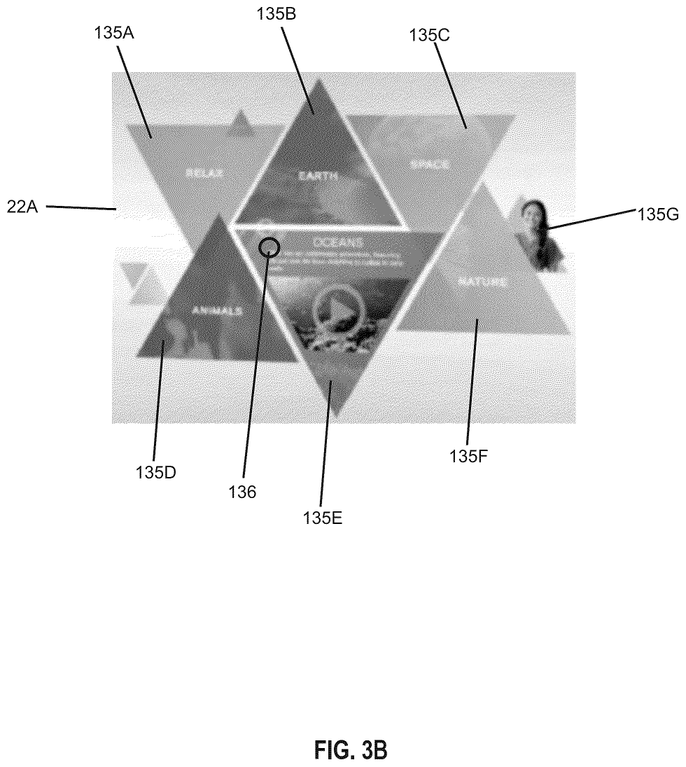

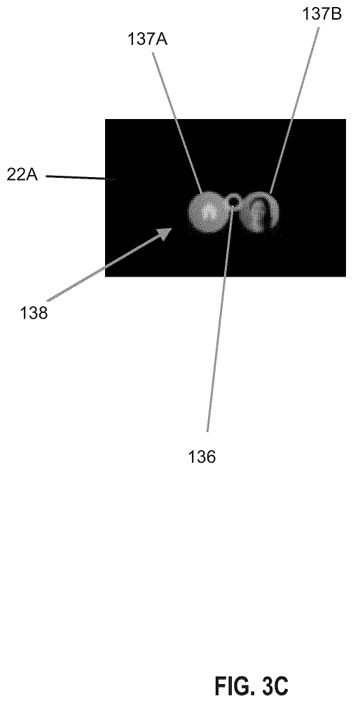

An example of a display 22A and/or 22B is shown in FIG. 3A, with each image being referred to as display 22A for ease of explanation. Initially, at the top of FIG. 3A, the display 22A is displaying a generated image, as opposed to the surroundings captured by camera 30. This generated image shows three categories for the user to select from, “Travel” 35A, “Relax” 35B and “Kids” 35C in a “Main Menu”, which can be any image the display 22A presents the user upon wearing the headset 1. These categories are examples, in other embodiments, any category of media presentation can be provided for selection by the user, including one category, two categories, four categories or more.

In FIG. 3A, the user moves their eye to cause the cursor image 36 to move over on to one of the displayed categories. The cursor image 36 is moved based on the detected the gaze direction of the user's eye. Optionally, the display 22A can display images according to a foveated rendering procedure where the cursor image 36 is considered the user's focal point. The foveated rendering images of display 22A can be the result of rendering resources being concentrated around the area of the cursor image 36 so that an area around the cursor image is rendered in high-resolution as opposed to other areas of the display 22A which are rendered at a lower resolution.

After the cursor image 36 is moved to one of the categories for a period of time, for example about 1 second, the display 22A can then display an image of the Sub layer Menu, which includes one, in this example two, three or more subcategories. In this example, two subcategories “Ocean” 35BA and “Space” 35BB are shown. The user again moves their eye to cause the cursor image 36 to move over on to one of the displayed subcategories. After the cursor image 36 is moved to one of the subcategories for a period of time, for example about 1 second, the display 22A can then play a media presentation within that subcategory.

In the example shown in FIG. 3A, the user selected “Space” 35BB, which causes media presentation 38 to begin playing.

From the media presentation 38, the user can move the cursor image 36 for further navigation, such as moving the cursor image 36 to a pause area 40 of the display 22A to pause the media presentation. The user can move the cursor image 36 to a home area 42 of the display 22A to revert back to the “Sub Layer Menu” or the “Main Menu”.

Another embodiment of a user interface that can be provided to a user on display 22A and/or 22B is shown in FIGS. 3B-3C.

Initially, at the top of FIG. 3B, the display 22A is displaying a generated image, as opposed to the surroundings captured by camera 30. This generated image shows several categories for the user to select from, “Relax” 135A, “Earth” 135B, “Space” 135C, “Animals” 135D, “Oceans” 135E, and “Nature” 135F in a “Main Menu”, which can be any image the display 22A presents the user upon wearing the headset 1. Also included is a category 135G for a sub-menu, which can cause the display 22A to display a sub-menu of categories for the user to select from, such as categories directed to pre/post treatment for the particular procedure the user will be receiving, an educational category directed to educating the user on the particular procedure (or any other procedures of interest) the user will be receiving, as well as a category directed to additional suggested or elective procedures, which can include pricing for such categories as well as education about them, for example. While this sub-menu is displayed, there will be an option for the user to select to return to the menu shown in FIG. 3B These categories of the main menu and sub-menu are examples, in other embodiments, any category of media presentation can be provided for selection by the user, including one category, two categories, three categories, four categories, five categories, six categories, eight categories or more.

In FIG. 3B, the user moves their eye to cause the cursor image 36 to move over on to one of the displayed categories. The cursor image 136 is moved based on the detected the gaze direction of the user's eye. Optionally, the display 22A can display images according to a foveated rendering procedure where the cursor image 136 is considered the user's focal point. The foveated rendering images of display 22A can be the result of rendering resources being concentrated around the area of the cursor image 136 so that an area around the cursor image is rendered in high-resolution as opposed to other areas of the display 22A which are rendered at a lower resolution.

After the cursor image 136 is moved to one of the categories for a period of time, for example about 1 second, the display 22A can then modify the size and/or placement of the category. In this example, the cursor image 136 is moved to the “Oceans” 135E category, which causes the “Oceans” 135E category to become larger than the other displayed categories and also causes the “Oceans” 135E category to display further detail about the video(s), such as descriptions and/or synopsis and/or a representative image of the video(s) of the category. After the cursor image 136 remains on the enlarged category for a period of time, for example about 1 second, the enlarged category can include a further image, such as a play sign and/or circle, that can change its representation to demonstrate the passing of time until the predetermined period of time is complete, after which the selection is deemed made and a video of the selected category can begin.

While a video is playing on the display 22A, or at any time the headset 1 is in use, the user can move their eye (for example to a vertically down area, but in other embodiments it can be any suitable direction) to cause the cursor image 136 to move cause a separate sub-menu 138 to be displayed, as shown in FIG. 3C. This separate sub-menu 138 can provide one, two or more options to the user. In the embodiment of FIG. 3C, two options are displayed, option category 137A—to go back to the main menu such as that shown in FIG. 3B, or, option category 137B—to go to directly to the main menu sub-menu, similarly to selecting category 135G in FIG. 3B.

In other embodiments, the embodiment of the user interface of FIG. 3A can be shown on display 22A and/or 22B, in other embodiments the user interface of FIGS. 3B-3C can be shown on display 22A and/or 22B, and in other embodiments elements of both the user interface of FIG. 3A and elements of the user interface of

Although not shown in FIG. 3A-3C, the user may also be able to move the cursor image 36 to a portion of the display 22A to mute or unmute an audio component of the media presentation. The user could also move the cursor image 36 to an adjacent portion of the display 22A to control volume level, as desired.

As one example of the situation the headset 1 would be used is in a doctor's office, dentist's office, surgical office etc. during which a user is a patient that is undergoing an examination and/or procedure. The categories 35A, 35B and 35C can be presented to the user so that the user can chose a media presentation that may soothe themselves during the examination and/or procedure. Using detections of eye gaze direction, the user can make their selections without the use of their hands, which is advantageous during examinations and/or procedures, since use of their hands may cause undesired motion or may be hindered or blocked by the person conducting the examination and/or procedure. Alternatively or in addition to detecting eye gaze, the headset 1 can include a gyroscope, or any other suitable orientation detector, so that the orientation of the user's head can be used to choose a media presentation and/or move a cursor as discussed below.

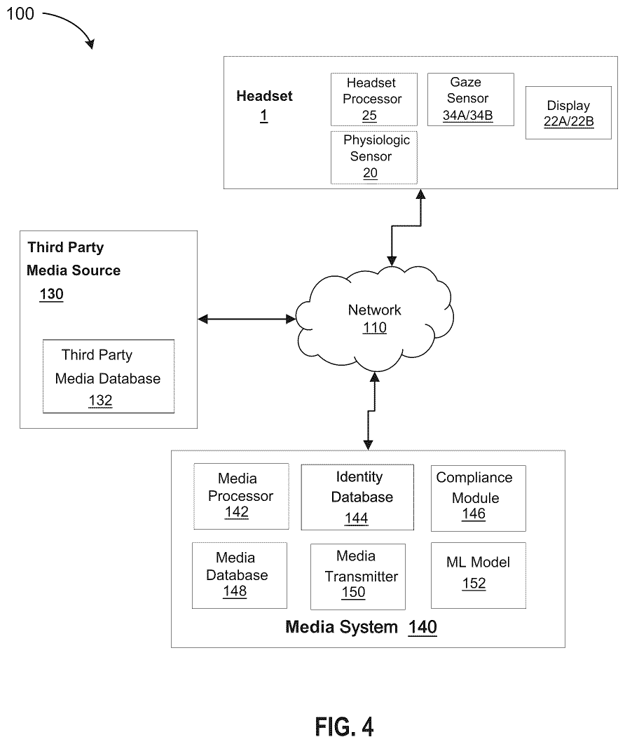

A description of a network environment the headset 1 can operate in is shown in FIG. 4. FIG. 4 is a block diagram of a network environment 100 for providing media presentations to the headset 1. The network environment 100 includes a network 110 connected to the headset 1, one or more third-party media sources 130, and a media system 140.

Referring to FIG. 4 in more detail, the network 110 is a network for communication between the headset 1, the media system 140 and, optionally, third party media source 130. An illustrative example network 110 is the Internet. The network 110 may be composed of multiple connected sub-networks or autonomous networks. The network 110 can be a local-area network (“LAN”), such as a corporate intranet, a metropolitan area network (“MAN”), a wide area network (“WAN”), an inter-network such as the Internet, a virtualized network, or a peer-to-peer network; e.g., an ad hoc WiFi peer-to-peer network. In some implementations, a wireless portion of the network 110 follows one of the IEEE 802.11 standards or wireless communications standards, such as WiMax, HSPA, LTE, etc. Any type and/or form of data network and/or communication network can be used for the network 110. It can be public, private, or a combination of public and private networks. In general, the network 110 is used to convey information between devices; e.g., for communication between the headset 1 and the media system 140.

The third-party media source 130 is a system of a third party or multiple third parties, such as an online video provider (e.g., YouTube®, Netflix®, etc.), that includes a third-party media database 132 storing various media presentations. The media presentations stored in third party media database 132 may be accessed by the media system 140 and be caused to be transmitted to the headset 1 for viewing by the user of headset 1.

The third-party media source 130 and the headset 1 interact with the media system 140. In one embodiment, media system 140 includes a media processor 142, an identity database 144, an optional compliance module 146, a media database 148, an optional media transmitter 150, and a machine learning module (MLM) 152. The media system 140 performs methods further described below.

The media system 140 includes the media processor 142, such as a processor 704 noted in FIG. 7 below.

The media system 140 also includes the identity database 144. The identity of past users of the headset 1 can be stored in identity database 144, with the stored identity information including, for example, any or all of the following data such as customer name, address, date of birth, educational background, employment status, type of employment, race, marital status, family status (e.g. number and age of children), past physiological responses (e.g. increased heart rate when a specific procedure is being performed), medical history, history of prescribed medication(s), user identified preferences (ocean media presentations as opposed to mountain video presentations), etc. The identity database 144 can also include a history of selected media presentations by the particular user, as well as physiologic data of that particular user before, during and after selection of the selected media presentations. The identity database 144 can also include a history of selected media presentations by other users of the same, or nearly the same, estimated age as the current user of the headset 1 based on the age estimation ability noted above.

The optional compliance module 146 can operate in conjunction with the MLM 152 so that certain government and/or specific rules are taken into account. The optional compliance module 146 could influence MLM 158 operations as well as any other outputs of the media system 140. The optional compliance module 160 can access a database within the media system 140, and/or the optional compliance module 146 can actively contact third party rules databases, and/or the optional compliance module 146 can update a database within the media system 146 based on input received from a specific user and/or a third party at the facility the headset 1 is operating in.

For example, the optional compliance module 146 can access and take into account laws and/or video based rules for the age of a user (the age being either input as part of the user selection, or estimated as noted herein). For example, for users under the age of 17, based on information in the identity database 144, the optional compliance module 146 would not allow the user to view or select a media presentation that was rated as “Mature”, rated R, or indicated as not being appropriate for users under the age of 17. As another example, the optional compliance module 146 can access and take into account certain rules created by operators at facilities that the headset 1 is being operated in. Certain media presentations could then be allowed, modified, or prevented from transmission from the third party media database 132 and/or the media database 148.

The media database 148 of the media system 140 can store various media presentations that can be transmitted to the headset 1. The media database 148 can be a relatively large library of possible media presentations that can be selected, which can be a library of media presentations selected by the operator of the facility of the headset 1, and/or a preset library provided by the operator of the media system 140. In addition, as user's select media presentations present on third party media database 132, that media presentation can be transmitted directly between the third-party media database 132 and the headset 1 and/or the media presentation present on third-party media database 132 can be added to the media database 148, and then transmitted from the media database 148 to the headset 1.

To transmit the media presentation from the media system 140 to the headset 1, the media system 140 can include a media transmitter 150. The media transmitter 150 can be a module or portion of any component of the media system 140, or a separate hardware element that is capable of wired or wireless data transmission with the media system 140. The media transmitter 150 can provide an outputted data feed of the media presentation, through network 110, to the headset 1.

The media transmitter 150 can also receive input, through network 110, by parties that can transmit input to the media system 140. For example, one or more third parties, such as operators of the headset 1 can transmit data that is received by the media transmitter 150.

As one example with the media transmitter 162, an output from the ML model 152 of a certain expected probability of selection of a media presentation for providing to a particular user of the headset 1 can be viewed. In this example, a third party, such as an operator of the headset 1, may modify any input to the headset 1 and/or input to the ML model 152, and received updated data about how a particular user and/or group of users deviated from any suggested media presentations. The third party, such as the operator of the headset 1, can view selected media presentation data for one user of the headset 1, all users of the headset 1 at one location, and/or all users (or some subset thereof) of the headset 1 at a plurality of locations.

Data received through the media transmitter 150 can be used by the media system 140 to impact any other element of the media system 140, and impact resultant data sent by the media system 140, through network 110, to the third-party media source 130 and/or the headset 1.

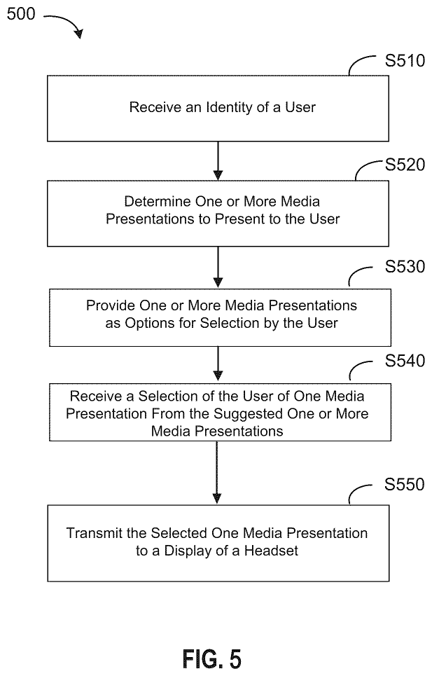

FIG. 5 is a flowchart of a method of providing media presentations to a user according to an embodiment. The method 500 begins at step S510 where an identity of a user of the headset 1 is received by the media system 140. The identity of the user can be their actual identity, or an estimated identity as discussed herein. The actual identity of the user can be manually input by the user themselves, manually input by an operator of the headset, determined by the media system 140 through a review process of a scheduling software, by receiving a biometric identification of the user, such as a fingerprint, eye scan, facial recognition, etc. Alternatively, or in addition to the input of the identity of the user of the headset 1, the estimated identity of the user can be determined by estimating the age of the user of the headset 1 (without their identity being input) and the estimated identity can be used as an age identity of the user. Thus, Step S510 can include reception of the identity of the user of the headset 1 directly, and/or an estimate of the user's age as noted above to represent their identity, with the method 500 continuing as further discussed.

One advantage of estimating the user's age rather than receiving the user's identity is the lack of personal details about the user that are to be stored and/or transmitted, such as the user's name, address, date of birth, educational background, employment status, type of employment, race, marital status, family status, medical history, etc.

The identity database 144 can then be accessed so that the stored identity information for that user can be accessed.

In some embodiments, the method 500 proceeds directly from S510 to S530, thus S520 is optional. In these embodiments that proceed directly from S510 to S530 the one or more media presentations presented to the user for their selection can be predetermined and/or default selections.

In embodiments where the method proceeds from S510 to S520, after access of the stored identity information (or access of stored information of others of the same or similar estimated age), a determination of one or more media presentations that will be provided to the user as options is made. This determination can be made through a manual input by the user themselves, a manual input by an operator of the headset, and/or a determination by the MLM 152. This determination of the one or more media presentations to be presented for selection for each user can occur each time the user is identified (or age is estimated as discussed herein), with the determined one or more media presentations optionally changing over time based on data of other users.

The determination of the one or more media presentations to provide to the user can be customized by the MLM 152 based on the particular user's stored identity information (or age estimation as discussed herein), such as previous media presentations selected by the user, duration of viewing of the previously selected media presentations, physiologic measurements at time of previous selections, and similar selections made by other user's that have similar identity information, etc.

As one example of a customized one or more media presentations to present to the user, the MLM 152 can select the same media presentations presented to the user previously, since based on the user's identity information, the user made a single selection of one of the one or more media presentations and viewed that media presentation for duration of wearing the headset 1. As another example of a customized one or more media presentations to present to the user, the MLM 152 can determine what one or more media presentations are popularly selected by other users of similar identify information (estimated or input), for example similar age (input or estimated), and/or similar blood pressure, etc., and present those one or more media presentations to this user.

The MLM 152 can also be updated at real-time, or substantially real-time, with data of other user's selections of media presentations as their selections are made. Thus, considerations and outputs of the MLM 152 can be continually, or substantially continually, updated throughout many typical days of operation based on updated data feeds received by the media system 140 itself, or from other media systems that transmit data to the media transmitter 150 of media system 140.

At step S530, the one or more media presentations that have been determined for presentation to the user are presented to the user on the display 22A/22B of the headset 1. This presentation can appear like one of the illustrations shown in FIG. 3A-3C. The user can then direct their gaze to one of the media presentations, with their gaze being detected by the gaze sensor 34A/34B, to select one media presentation of the one or more media presentations to view and/or view and listen to.

Next, in step S540 the selection of the one media presentation, from the suggested one or more media presentations, made by the user is received by the media system 140. If the selected one media presentation is stored within the media database 148 of the media system 140, the one media presentation is transmitted through network 110 from the media database 148 to the display 22A/22B of the headset 1 in step S550. If the selected one media presentation is stored within the third-party media database 132 of the third party media source 130, the one media presentation is transmitted through network 110 from the third party media database 132 to the display 22A/22B of the headset 1 in step S550. If the selected one media presentation is stored locally within a portion of the headset 1, the one media presentation is transmitted from a memory of the headset 1 to the display 22A/22B of the headset 1 in step S550.

As used herein, the term “machine learning model” is meant to include a single machine learning model or an ensemble of machine learning models, which can optionally be used to at least partially perform one or more steps S520 and S530. Each model in the ensemble may be trained to infer different attributes. The MLM 152 can be a program module of a processor of the media system 140 that performs the methods and functions described herein. The MLM 152 can be programmed into the integrated circuits of the media processor 142.

The results output by the MLM 152 are data attributes, which are received as input by the one or more modules of the media system 140. The MLM 152 can be useful to predict data attributes that can be difficult or cumbersome to develop using more conventional approaches. For example, a customized list of one or more media presentations determined to be presented to the user for a similar group of users (based on similarities of their (actual or estimated) identity information) may be used as an input to the MLM 152, which then predicts various data attributes, such as expected selection of media presentation. The media system 140 can then control the one or more media presentations to present to a specific user.

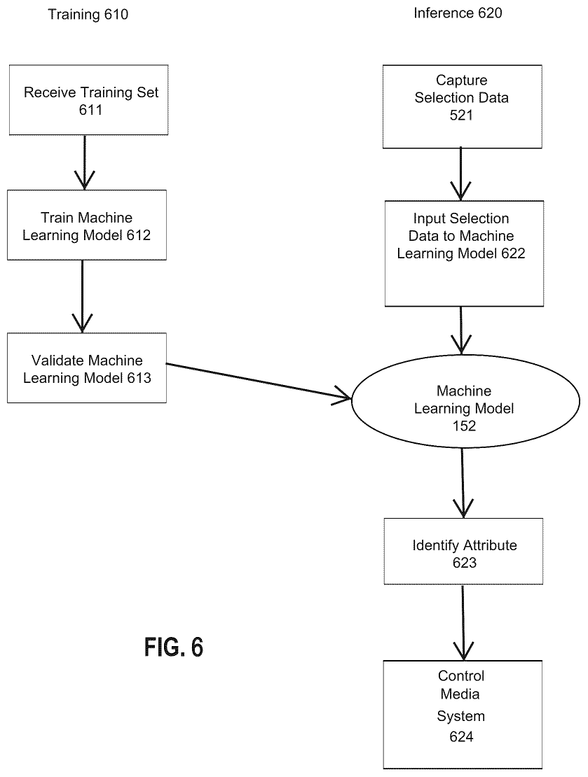

As described above, MLM 152 is especially useful to learn complex relationships and/or to automatically adapt to changes. FIG. 6 is a flow diagram illustrating training and operation of a machine learning model (MLM 152), according to an embodiment. The process includes two main phases: training 610 the MLM 152 and inference (operation) 620 of the MLM 152. These will be illustrated using an example where the machine learning model learns to predict which media presentations to present to a user based on historical data. The following example will use the term “machine learning model” but it should be understood that this is meant to also include an ensemble of machine learning models.

A training module (not shown) performs training 610 of the MLM 152. In some embodiments, the MLM 152 is defined by an architecture with a certain number of layers and nodes, with biases and weighted connections (parameters) between the nodes. During training 610, the training module determines the values of parameters (e.g., weights and biases) of the MLM 152, based on a set of training samples that include historical identity information of other users and/or historical identity information of one user (known user or estimated user age).

The training module receives a training set 611 for training the machine learning model in a supervised manner. Training sets typically are historical data sets of selections of media presentations by other users, and their associated identity information (including their physiologic measurements at the time of selection and after selection). The training set samples the historical data sets of previous selections, under varying or a wide range of different conditions. The corresponding responses are alterations of the media presentation(s) being selected by other users over time.

The following is an example of two training samples:
i. User A is Male, 54 years old, lives in New York, has an elevated pulse;
ii. Selected a media presentation X, viewed the media presentation entirety;
iii. Pulse rate decreased to within expected values.
i. User B is Female, 48 years old, lives in New Jersey, has elevated blood pressure;
ii. Selected media presentation Y, viewed for 2 minutes as blood pressure increased further;
iii. Selected media presentation Z, viewed media presentation Z for its entirety;
iv. Blood pressure decreased to within expected values.

The MLM 152 can use these examples in training machine learning model 612, to learn that for other users similarly situated to User B's facts as compared to User A, to offer media presentation Z.

In typical training 610, a training sample is presented as an input to the MLM 152, which then predicts an output for a particular attribute. The difference between the machine learning model's output and the known good output is used by the training module to adjust the values of the parameters (e.g., features, weights, or biases) in the MLM 152. This is repeated for many different training samples to improve the performance of the MLM 152 until the deviation between prediction and actual response is sufficiently reduced.

The training module also can validate 613 the trained MLM 158 based on additional validation samples. The validation samples are applied to quantify the accuracy of the MLM 158. The validation sample set includes additional samples of inputs of customized available discounts and corresponding responses of activation or reactivation. The output of the MLM 158 can be compared to the known ground truth. To evaluate the quality of the machine learning model, different types of metrics can be used depending on the type of the model and response.

Classification refers to predicting what something is, for example if an image in a video feed is a person. To evaluate classification models, F1 score may be used. The F1 score is a measure of predictive accuracy of a machine learning model. The F1 score is calculated from the precision and recall of the machine learning model, where the precision is the number of correctly identified positive results divided by the number of all positive results, including those not identified correctly, and the recall is the number of correctly identified positive results divided by the number of all samples that should have been identified as positive.

Regression often refers to predicting quantity, for example, how much energy is consumed. To evaluate regression models, coefficient of determination, which is a statistical measure of how well the regression predictions approximate the real data points, may be used. However, these are merely examples. Other metrics can also be used. In one embodiment, the training module trains the machine learning model until the occurrence of a stopping condition, such as the metric indicating that the model is sufficiently accurate or that a number of training rounds having taken place.

Training 610 of the MLM 152 can occur off-line, as part of the initial development and deployment of the media system 140. Under this option, training samples from historical users (and/or historical data of the specific user themselves) can be used to train the MLM 152. This training data can be all available historical user information, or a portion of the historical user information for other users that are similarly situated such as, for example, being the same/similar age, same/similar geographic location, same/similar physiologic data at the time of selection, etc.

The trained MLM 152 can then be deployed in the field. Once deployed, the MLM 152 can be continually trained 610 or updated. For example, the training module uses data captured in the field, during use of the media system 140 (and other similarly situated media systems), to further train the MLM 152. The training 610 can occur within the media system 140 and/or in an external database.

In operation 620, selection data of the specific user and/or selection data of other user(s) are captured in 621. The MLM 152 then uses that captured data as input in 622 to the MLM 152. The MLM 158 then determines the one or more media presentations that should be presented to a particular user that have the highest likelihood of being selected. In one approach, the MLM 152 calculates 623 a probability of possible different outcomes, for example the probability that a user will select a particular media presentation. Based on the calculated probabilities, the MLM 152 identifies 623 which attribute is most likely. In a situation where there is not a clear-cut winner, the MLM 152 may identify multiple attributes and seek verification, such as from a third party.

Continuing the above examples, Patient A is selected to receive an updated, customized available discount. The inputs to the MLM 158 are the following:
I. User B is Female, 48 years old, lives in New Jersey, has elevated blood pressure;
II. Selected media presentation Y, viewed for 2 minutes as blood pressure increased further;
III. Selected media presentation Z, viewed media presentation Z for its entirety;
IV. Blood pressure decreased to within expected values;

The MLM 152 predicts the following attributes 623: predicted presentation of media presentation Z as a choice of first selection will increase the probability that User B will select presentation Z initially, and experience a resultant and/or concurrent decrease in blood pressure.

The media system 140 can then transmit, through network 110, the updated, customized selection that includes media presentation Z initially to the headset 1 by using the responses predicted by the MLM 152 to make informed decisions.

The media system 140 uses the MLM 152 to evaluate different possible courses of action. In this example, the MLM 152 functions as a simulation using an original or predetermined one or more media presentation to present to a user, or one or more updated, customized one or more media presentations to be presented to the user, and can provide selection probabilities for each of these simulations. The media system 140 can take different courses of action to affect a new user, or a user that has previously selected one media presentation for suggested one or more media presentations.

A “policy” is a set of actions performed by the media system 140. In the above scenario, some example policies are as follows:
Policy 1: For users below a certain age, provide more media presentation options that are associate with a “Youth” rating.
Policy 2: For users experiencing an elevated blood pressure, provide more media presentations showing a beach scene.

The policies can be a set of logic and rules determined by domain experts. They can also be learned by the media system 140 itself using reinforcement learning techniques. At each time step, the media system 140 evaluates the possible actions that it can take and can choose the action that maximizes evaluation metrics or provide an option for selection by a third party of an action. The media system 140 does so by simulating the possible subsequent states that may occur as a result of the current action taken, then evaluates how valuable it is to be in those subsequent states. For example, a valuable state can be that a user selects one media presentation that is originally offered for selection, and views that media presentation in its entirety. This valuable state can be static or could change as the media system 140 learns that to achieve a certain probability of media presentation selection.

Based on a goal or target selection of media presentation, a policy engine of the media system 140 determines which polices might be applicable. This can be done using a rules-based approach, for example. The MLM 152 predicts the result of each policy. The different results are evaluated and a course of action is selected or provided for selection by others. A set of metrics is used to evaluate the policies.

Metrics can be defined to suit particular needs. For example, metrics to evaluate users of various ages. In one embodiment, the metrics can be defined to achieve a selection probability of 85% for a specified user or group of users.

To simulate subsequent states, the media system 140 uses the trained MLM 152. When underlying conditions (e.g. other media presentations become available) are changing, the MLM 152 can make predictions on what most likely will be observed as a result of actions taken. Based on these predictions, media system 140 chooses a policy or action that most likely maximizes the metric of interest, e.g., the probability of selection being above a target threshold.

To decide which action to take from a state, the media system 140 may employ techniques of exploitation and exploration. Exploitation refers to utilizing known information. For example, a past sample shows that under certain conditions, a particular action was taken, and good results were achieved. The media system 140 may choose to exploit this information, and repeat this action if current conditions are similar to that of the past sample. Exploration refers to trying unexplored actions. With a pre-defined probability, the media system 140 may choose to try a new action. For example, 10% of the time, the media system 140 may perform an action that it has not tried before but that may potentially achieve better results.

Returning to FIG. 6, the selection of the user of one media presentation is received by the media system 140 Systems, apparatus, and methods described herein may be implemented using computers operating in a client-server relationship. Typically, in such a system, the client computers are located remotely from the server computer and interact via a network. The client-server relationship may be defined and controlled by computer programs running on the respective client and server computers.

A high-level block diagram of an example computer 700 that may be used to implement systems, apparatus, and methods described herein is depicted in FIG. 7. Computer 700 includes a processor 704 operatively coupled to a data storage device 712 and a memory 710. Processor 704 controls the overall operation of computer 700 by executing computer program instructions that define such operations. The computer program instructions may be stored in data storage device 712, or other computer readable medium, and loaded into memory 710 when execution of the computer program instructions is desired. Thus, the method and workflow steps or functions of FIGS. 3-6 can be defined by the computer program instructions stored in memory 710 and/or data storage device 712 and controlled by processor 704 executing the computer program instructions. For example, the computer program instructions can be implemented as computer executable code programmed by one skilled in the art to perform the method and workflow steps or functions of FIGS. 3-6. Accordingly, by executing the computer program instructions, the processor 704 executes the method and workflow steps or functions of FIGS. 3-6. Computer 700 may also include one or more network interfaces 706 for communicating with other devices via a network. Computer 700 may also include one or more input/output devices 708 that enable user interaction with computer 700 (e.g., display, keyboard, mouse, speakers, buttons, etc.).

Processor 704 may include both general and special purpose microprocessors, and may be the sole processor or one of multiple processors of computer 700. Processor 704 may include one or more central processing units (CPUs), for example. Processor 704, data storage device 712, and/or memory 710 may include, be supplemented by, or incorporated in, one or more application-specific integrated circuits (ASICs) and/or one or more field programmable gate arrays (FPGAs).

Data storage device 712 and memory 710 each include a tangible non-transitory computer readable storage medium. Data storage device 712, and memory 710, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

Input/output devices 708 may include peripherals, such as a printer, scanner, display screen, etc. For example, input/output devices 708 may include a display device such as a cathode ray tube (CRT) or liquid crystal display (LCD) monitor for displaying information to the user, a keyboard, and a pointing device such as a mouse or a trackball by which the user can provide input to computer 700.

One skilled in the art will recognize that an implementation of an actual computer or computer system may have other structures and may contain other components as well, and that FIG. 7 is a high level representation of some of the components of such a computer for illustrative purposes.

The described embodiments and examples of the present disclosure are intended to be illustrative rather than restrictive, and are not intended to represent every embodiment or example of the present disclosure. While the fundamental novel features of the disclosure as applied to various specific embodiments thereof have been shown, described and pointed out, it will also be understood that various omissions, substitutions and changes in the form and details of the devices illustrated and in their operation, may be made by those skilled in the art without departing from the spirit of the disclosure. For example, it is expressly intended that all combinations of those elements and/or method steps which perform substantially the same function in substantially the same way to achieve the same results are within the scope of the disclosure. Moreover, it should be recognized that structures and/or elements and/or method steps shown and/or described in connection with any disclosed form or embodiment of the disclosure may be incorporated in any other disclosed or described or suggested form or embodiment as a general matter of design choice. Further, various modifications and variations can be made without departing from the spirit or scope of the disclosure as set forth in the following claims both literally and in equivalents recognized in law.

What is claimed is:

1. A system, the system comprising:
a headset configured to cover at least a portion of a user's eye, the headset comprising:
a sensor configured to detect a gaze direction of at least one eye of the user; and
at least one display configured to display a media selection; and
a processor configured to:
determine one or more media presentations to provide as options to the user on the at least one display; and
receive the users selection of one media presentation, based on the gaze direction of the user, from the one or more media presentations.

2. A method of providing media presentations to a user, the method comprising:
receiving an identity or an estimated identity of the user;
determining one or more media presentations to present to a user;
providing one or more media presentations as options for selection by the user;
receiving a selection of the user of one media presentation from the provided one or more media presentations; and
transmitting the selected one media presentation to a display of a headset.
